(19) United States
(12) Patent Application Publication
(10) Pub. No.: US 2011/0063532 A1
(43) Pub. Date: Mar. 17, 2011

(54) IMAGE DISPLAY DEVICE

(75) Inventor: Kiyotaka NAKASE, Osaka (JP)

(73) Assignee: PANASONIC CORPORATION, Osaka (JP)

(21) Appl. No.: 12/882,959

(22) Filed: Sep. 15, 2010

(30) Foreign Application Priority Data
Sep. 17, 2009 (JP) 2009-215341

(51) Int. Cl. H04N 5/64

(52) U.S. Cl. 348/843; 348/E05.128

(57) ABSTRACT

The image display device is provided with a panel for displaying images, a chassis supporting the display panel on its front surface, circuit boards arranged within a specific region of the back surface of the chassis, and a back cover having an edge portion that covers the outside of the specific region of the back surface of the chassis, and a projecting portion that projects inside the edge portion toward the side opposite to the chassis and that accommodates the circuit boards. The edge portion has a plurality of drawn portions extending toward a particular direction.

### BACKGROUND OF THE INVENTION

1. Field of the Invention

The present invention relates to an image display device for displaying images, such as television images.

2. Description of Related Art

In recent years, with a reduction in thickness of image display devices for displaying images such as television images, image display devices using a so-called flat display panel such as a plasma display panel and a liquid crystal panel have become mainstream, instead of conventional CRTs.

FIG. 6 is a schematic sectional view showing an internal configuration of a plasma display device as an example of such a flat image display device. It should be noted that the upward and downward direction means the upward and downward direction (that is, the vertical direction) of a plasma display device in the normal use position (that is, laterally placed), and the left and right direction means a direction orthogonal to this (that is, the horizontal direction) in the following description. Further, the display screen side is referred to as the forward direction, and the back cover side is referred to as the backward direction.

As indicated in FIG. 6, a plasma display device 3 is provided with a front cover 200 and a back cover 300. A PDP 100 (Plasma Display Panel) for displaying images, a chassis 400 supporting the PDP 100 on its front surface, and a plurality of circuit boards 500 that are mounted to the back surface of the chassis 400 for driving the PDP 100 are accommodated inside the space surrounded by the front cover 200 and the back cover 300. For example, JP 2003-162228 A discloses such a configuration as a conventional example.

### SUMMARY OF THE INVENTION

There is a growing demand for a reduction in thickness of image display devices using a flat display panel such as a plasma display device. In response to this, a visual reduction in thickness can be achieved, for example, by a configuration in which circuit boards are arranged concentrically in the center of the back surface of a chassis so that the thickness of the portion corresponding to the peripheral edge of the back cover can be reduced. FIG. 7 shows a specific example of a structure with a reduced thickness. FIG. 7 is a perspective view showing a plasma display device having the structure with a reduced thickness, as viewed from the back side thereof. A step is provided on a back cover 600 for reducing the thickness in the upper portion and the left and right portions of a plasma display device. Thus, a reduction in thickness of the upper portion and the left and right portions that are likely to come into view can yield a design that has a visual effect of thickness reduction.

However, such a configuration has a problem in that the strength of the portion having a reduced thickness decreases, which may cause the panel to be damaged if the device is dropped or subjected to an external force.

The present invention has been devised in view of the problem described above, and an object thereof is to provide an image display device that can achieve a reduction in thickness while suppressing the decrease in strength.

In order to solve the above-mentioned problem, the image display device of the present invention is provided with a panel for displaying images, a chassis supporting the display panel on its front surface, circuit boards arranged within a specific region of the back surface of the chassis, and a back cover having an edge portion that covers the outside of the specific region of the back surface of the chassis, and a projecting portion that projects inside the edge portion toward the side opposite to the chassis and that accommodates the circuit boards. In the image display device, the edge portion includes a plurality of drawn portions extending in a particular direction.

“Drawn portion” means a swelled out portion so as to hold a space extending in the particular direction, it may be a concave portion recessed toward the chassis or a convex portion projecting toward the side opposite to the chassis.

According to the image display device of the present invention, the circuit boards are arranged concentrically, and these circuit boards are accommodated in the projecting portion of the back cover. Therefore, it is possible to reduce the thickness of the portion defined by the edge portion located outside the projecting portion, thus allowing the apparent thickness to be reduced. Furthermore, it is possible to suppress a decrease in strength by providing the drawn portions in the edge portion. That is, an image display device that can achieve a reduction in thickness, while preventing the strength from decreasing, can be obtained.

### BRIEF DESCRIPTION OF THE DRAWINGS

FIG. 1 is a perspective view illustrating a configuration of a plasma display device 1 according to the first embodiment.

FIG. 2A is a sectional view taken along the line IIA-IIA in FIG. 1, and FIG. 2B is a sectional view taken along the line IIB-IIB in FIG. 1.

FIG. 3 is an enlarged partial view of FIG. 2A.

FIG. 4 is a sectional view showing a plasma display device 2 according to the second embodiment.

FIG. 5 is a sectional view taken along the line V-V in FIG. 4.

FIG. 6 is a schematic sectional view showing the internal configuration of a conventional plasma display device.

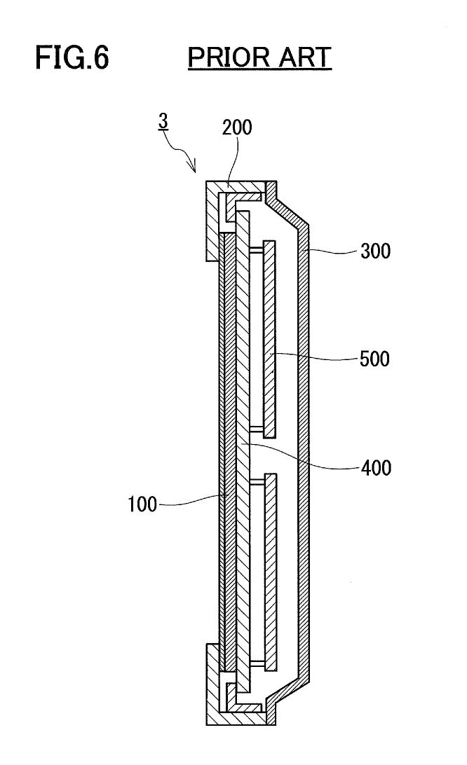

FIG. 7 is a perspective view showing a plasma display device having the structure with a reduced thickness as viewed from the back side thereof.

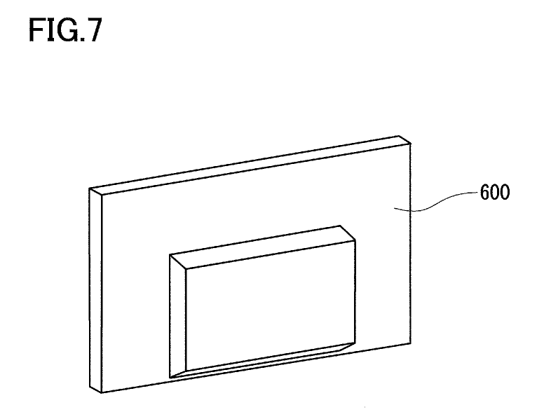

### DETAILED DESCRIPTION OF THE INVENTION

Hereinafter, embodiments for carrying out the present invention are described with reference to the drawings. It should be noted that the following descriptions are to be regarded as an example, and the present invention is not limited by these descriptions. Further, an example of a plasma display device is used as an image display device in the following descriptions, as in the conventional example.

### First Embodiment

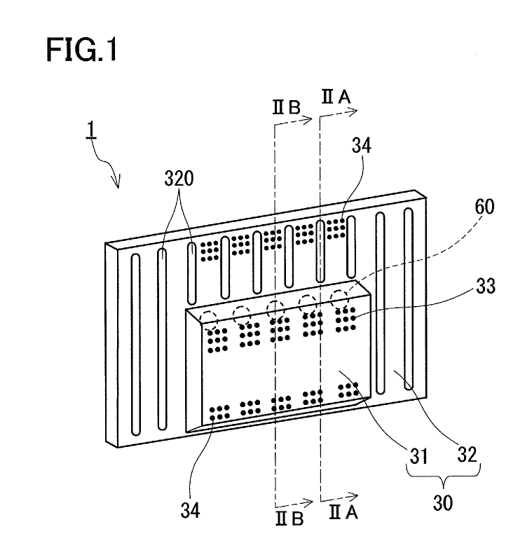

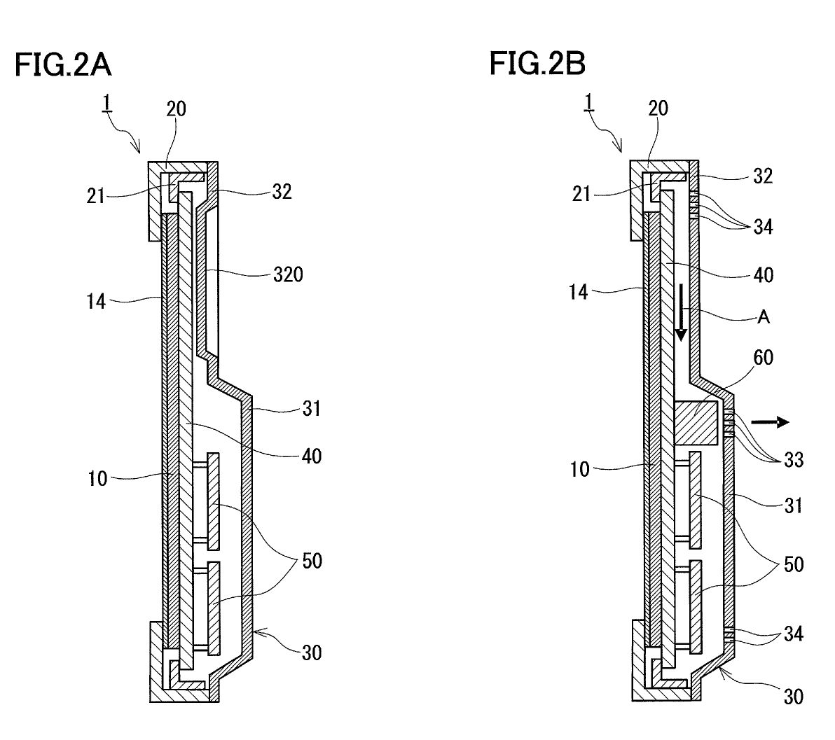

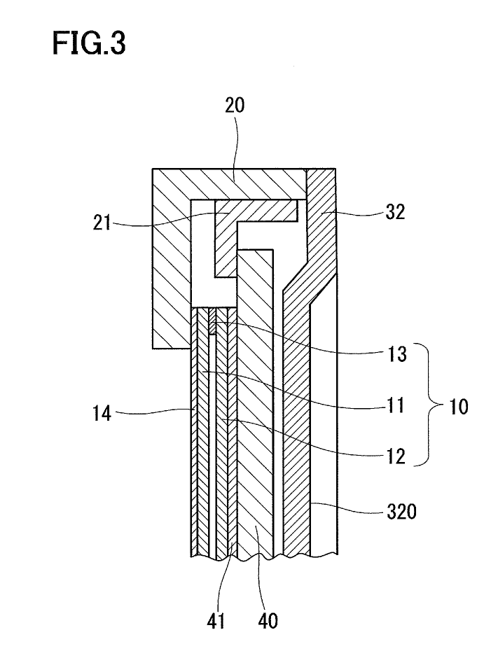

FIG. 1 is a perspective view illustrating a configuration of a plasma display device 1 according to the first embodiment of the present invention. FIG. 2A is a sectional view taken along the line IIA-IIA in FIG. 1, and FIG. 2B is a sectional view taken along the line IIB-IIB in FIG. 1. FIG. 3 is an enlarged partial view of FIG. 2A.

The plasma display device 1 is provided with a front cover 20 and a back cover 30. A PDP 10 as a display panel for displaying images, a chassis 40 supporting the PDP 10 on its front surface, and a plurality of circuit boards 50 that are mounted to the back surface of the chassis 40 for driving the PDP 10 are accommodated inside the space surrounded by the front cover 20 and the back cover 30. The plasma display device 1 has an elongated shape, viewed from the image display screen side, and generally is positioned such that the longitudinal direction is the horizontal direction and the short direction is the vertical direction (that is, the PDP 10 is in an upright position).

As indicated in FIG. 3, the PDP 10 has a front panel 11, a back panel 12 and a sealing member 13 formed along the periphery thereof. The front panel 11 and back panel 12 are bonded to each other with the sealing member 13 arranged on the edge portion of the main surface of each panel, and are spaced apart by the thickness of the sealing member 13. The front panel 11 and back panel 12 are formed of glass substrates and the like. The enclosed space that is sealed by the sealing member 13 between the front panel 11 and back panel 12 is filled with a rare gas such as Ne and Xe. An electric field is applied to the enclosed space, thereby causing electric discharge and light emission.

A front filter 14 is attached to the front surface of the PDP 10. The front filter 14 is formed of various filters such as an anti-reflection filter for preventing the reflection of outside light, and an electromagnetic wave shielding filter.

The front cover 20 is formed into a shape to constitute the front surface and the upper, lower, left and right side surfaces of the plasma display device 1. The portion of the front cover 20 constituting the front surface of the device 1 is provided with an opening so that the image display area of the PDP 10 should be exposed. The front cover 20 is made, for example, of a conductive member, such as aluminium with a thickness of about 1 mm. The front cover 20 is connected electrically to the electromagnetic wave shielding filter of the front filter 14. Further, the front cover 20 is connected to the back cover 30 that also is made of a conductive member as well. That is, the front cover 20, the back cover 30, and the front filter 14 form a shield housing that surrounds the PDP 10. The front cover 20 serves also as an escutcheon frame that covers the periphery of the image display screen of the PDP 10.

The chassis 40 is made of a metal having both good mechanical rigidity and good heat conductivity, such as aluminium. The chassis 40 has almost the same shape and area as the PDP 10 as viewed from the front and has a thickness, for example, of about 1.0 to 2.0 mm. As indicated in FIG. 3, the chassis 40 is bonded to the back surface of the back panel 12 in the PDP 10 over the entire surface thereof via an adhesive sheet 41 with heat conductivity. That is, the chassis 40 supports the PDP 10 that serves as a display panel, on its front surface. The chassis 40 is fixed to the front cover 20 via a fixing member 21 provided around the chassis 40.

The adhesive sheet 41 has an elongated shape and almost the same area as the PDP 10 as viewed from the front and has a thickness, for example, of about 0.5 to 2.0 mm. The adhesive sheet 41 interposed between the PDP 10 and the chassis 40 allows the PDP 10 basically made of glass substrates to be in close contact with the chassis 40 that is metal. Thus, the effect of heat conduction from the PDP 10 to the chassis 40 is enhanced. Therefore, the adhesive sheet 41 is preferably made of silicon or the like having both flexibility and heat conductivity.

The circuit boards 50 are constituted by a drive circuit board for driving the PDP 10, a signal processing circuit board for transmitting image signals to the PDP 10, and the like. The circuit boards 50 are fixed to a back surface of the chassis 40 with fixing members such as screws. In this embodiment, the circuit boards 50 are arranged within a specific region of the back surface of the chassis 40 so that they concentrate in the lower center of the back surface. That is, the specific region is the lower center region of the back surface of the chassis 40. It should be noted that the specific region is covered by a later-mentioned projecting portion 31 of the back cover 30.

The back cover 30 covers the chassis 40 and the circuit boards 50 from the back side thereof, and is connected to the front cover 20 at its peripheral edge portion. The back cover 30 is made, for example, of steel with a thickness of about 0.5 mm. The back cover 30 has an edge portion 32 that covers the outside of the specific region of the back surface of the chassis 40, and a projecting portion 31 that projects inside the edge portion 32 toward the side opposite to the chassis 40 and that accommodates the circuit boards 50. The plasma display device 1 has a thickness, for example, of about 1 cm in the portion corresponding to the edge portion 32 of the back cover 30. Further, the plasma display device 1 has a thickness, for example, of about 5 cm in the portion corresponding to the projecting portion 31 of the back cover 30.

A plurality of drawn portions extending in a particular direction are provided in the edge portion 32 of the back cover 30. In this embodiment, each drawn portion is a concave portion 320 recessed toward the chassis 40. The concave portions 320 are provided above and on both sides of the projecting portion 31, extending in the vertical direction while aligning in the horizontal direction. The concave portion 320 has a depth of about 2 to 5 mm, and a width of about 10 to 15 mm, for example. The concave portions 320 can be formed by concaving the edge portion 32 of a planar shape using a drawing process. In this embodiment, the concave portions 320 are formed at 10 points at equal intervals in the horizontal direction. Specifically, the concave portions 320 are formed at 6 points in the above portion of the projecting portion 31 and at 2 points for each of both sides thereof.

The length of the concave portions 320 is not limited specifically, and can be determined appropriately. In this embodiment, the concave portions 320 located above the projecting portion 31 and the concave portions 320 located lateral to the projecting portion 31 both have a length slightly shorter than the height of the edge portion 32 corresponding to each position.

A plurality of fans 60 are provided inside the projecting portion 31. The fans 60 are mounted to the chassis 40 via a mounting member, which is not illustrated. Air inlets 34 are provided in the upper portion of the edge portion 32 so as to be located at a position between adjacent pairs of the concave portions 320. Air outlets 33 are provided in the upper portion of the projecting portion 31 at a position corresponding to the middle between adjacent pairs of the concave portions 320. Furthermore, air inlets 34 are provided also in the lower portion of the projecting portion 31 in this embodiment. When the fans 60 are operated, airflow from the air inlets 34 to the air outlets 33 occurs between the chassis 40 and back cover 50, and the air in the space between the chassis 40 and the back cover 30 is emitted through the air outlets 33 to the outside.

It should be noted that the air inlets 34 and the air outlets 33 are not necessarily provided in the position illustrated in the figure. For example, in the case where the edge portion 32 of the back cover 30 has an outer peripheral edge portion that is bent forward, the air inlets 34 may be provided in the bent portion. Further, the air inlets 34 and the air outlets 33 may be provided, not on the main wall of the projecting portion 31 that faces the chassis 40, but on the peripheral wall thereof that broadens and extends from the peripheral edge of the main wall toward the chassis 40.

In this embodiment, a centrifugal fan is employed as the fans 60. Five fans 60 are provided in the upper region inside the projecting portion 31 at equal intervals in the horizontal direction so that air can be blown straight toward the air outlets 33. More specifically, the fans 60 each are arranged at a position corresponding to the middle between adjacent pairs of the concave portions 320 in the back cover 30. That is, the five fans 60 each are provided so as to be located between adjacent pairs of the concave portions 320 that are located above the projecting portion 31 among the concave portions 320 that are provided in the edge portion 32.

Descriptions for the configuration of the plasma display device 1 according to this embodiment have been given hereinbefore. Next, the operation of the plasma display device 1 is described.

As mentioned above, the plasma display device 1 has a reduced thickness in the upper portion and the left and right portions corresponding to the edge portion 32 of the back cover 30. Generally, the plasma display device 1 is positioned such that the back side thereof (the side of the back cover 30) faces the wall or the like. Therefore, a visual effect of reduced thickness can be obtained by reducing the thickness of the upper portion and the left and right portions that are likely to come into view.

However, a decrease in the strength of the plasma display device is caused by just simply providing the portions with reduced thickness. In this embodiment, a plurality of the concave portions 320 therefore are provided in the edge portion 32 of the back cover 30. The deformation of the back cover 30 due to stress can be prevented and the strength thereof can be enhanced by providing the concave portions 320. With such a configuration, it is possible to improve the strength in the thin portions of the plasma display device 1 and to prevent the damages of the plasma display device 1 such as breakage of the display panel when the device is dropped or subjected to an external force.

Further, the concave portions 320 are provided extending along the upright direction of the plasma display device 1, that is, the vertical direction, in this embodiment. Therefore, the space between the chassis 40 and the back cover 30 is partitioned by the concave portions 320. Thus, airflow paths are formed in the vertical direction. The fans 60 each are provided so as to correspond to the middle between adjacent pairs of the concave portions 320 in the back cover 30, that is, the above-mentioned airflow paths. Such a configuration allows the heat that has been generated from the PDP 10 and transferred to the chassis 40 to be dissipated efficiently by the fans 60. Specifically, air flows through the flow path as indicated by the arrow A in FIG. 2B, and the air is emitted through the air outlets 33, so that the heat is dissipated. Of course, the fans 60 also have the effect of dissipating the heat that has been generated from the circuit boards 50 inside the projecting portion 31 as well, owing to the air drawn through the air inlets 34 provided in the lower portion of the projecting portion 31.

It should be noted that although the projecting portion 31 is formed in the lower center of the back cover 30 in this embodiment, the formation of the projecting portion 31 is not limited thereto. A configuration in which the edge portion 32 is formed also in the lower portion and the projecting portion 31 is formed in the center portion is possible. With such a configuration, a visual effect of thin appearance can be achieved also in the case where the lower portion comes into the view, for example, when the plasma display device 1 is used in a wall mounted position.

Further, the concave portions 320 are provided at 10 points, and the five fans are provided in this embodiment. However, the number of them is not limited thereto and can be selected appropriately. Further, the length, the thickness (depth), and the width, etc. of the concave portions 320 can be selected appropriately, and it also is possible to form the concave portions 320 in various shapes in the same device.

### Second Embodiment

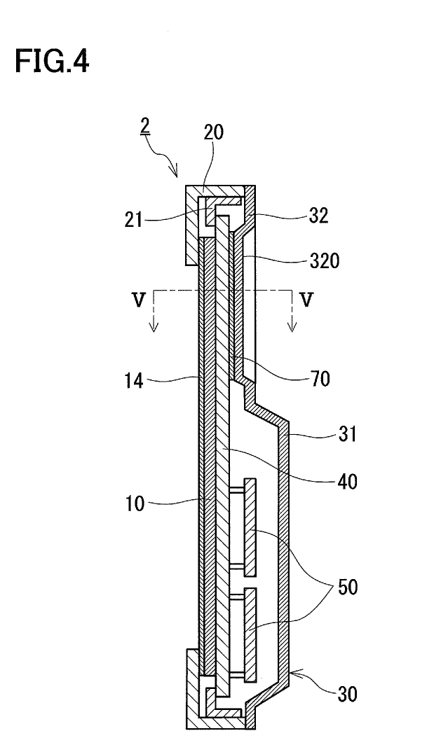

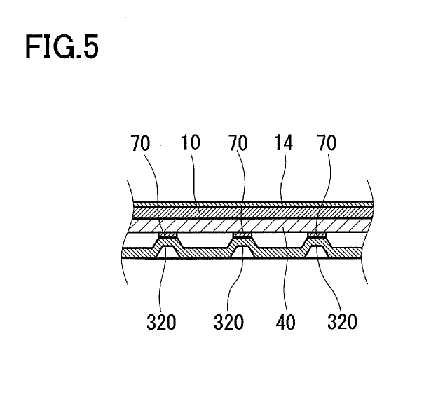

Next, the second embodiment of the present invention is described with reference to FIG. 4 and FIG. 5. The second embodiment differs from the first embodiment in that the concave portions 320 are in contact with the back surface of the chassis 40. Other configurations are the same as those in the first embodiment and thus descriptions thereof are omitted.

FIG. 4 is a sectional view including the concave portions 320 in the plasma display device 2 according to the second embodiment, and corresponds to FIG. 2A in the first embodiment.

In the plasma display device 2, the concave portions 320 provided in the edge portion 32 of the back cover 30 are in contact with the back surface of the chassis 40 via heat transfer sheets 70 with heat conductivity. As a material to form the heat transfer sheet 70, silicon, acrylic, or the like can be used, for example.

Each of the heat transfer sheets 70 has a strip shape with about the same length and width as the concave portions 320, and is arranged at a position corresponding to each concave portion 320, as indicated in FIG. 5. That is, each concave portion 320 is in contact with the back surface of the chassis 40 via the heat transfer sheet 70 across its full length.

Here, the necessity of heat dissipation in the PDP 10 is described. The PDP 10 is likely to have a high temperature because of the operational principle that uses gas discharge for displaying images. When the PDP 10 has a high temperature exceeding its limit due to insufficient heat dissipation thereof, the electrical capacity of the electrodes formed inside the PDP 10 changes, thus causing adverse effects such as the failure of normal discharge. For this reason, the PDP 10 needs to be maintained at a certain temperature (for example, 70 to 80° C.) or less. The heat-dissipation performance decreases particularly in the configuration in which the periphery of the device has a reduced thickness by providing the edge portion 32 in the back cover 30, since it also is difficult to add a heat dissipation member on the back side of the chassis 40.

In this embodiment, the use of the above-mentioned heat transfer sheets 70 enables the heat transferred from the PDP 10 to the chassis 40 to be transferred to the back cover 30 by heat conduction. That is, it is possible to enhance the heat dissipation effect on the PDP 10 further.

It should be noted that, although the concave portions 320 are brought into contact with the back surface of the chassis 40 via the heat transfer sheets 70 in this embodiment, they may be in contact directly with each other, or may be in contact via another heat conductive member (for example, screws). Such contact structures can be achieved at low cost. Further, a spring member and the like may be employed as a heat conductive member that brings the concave portions 320 into contact with the back surface of the chassis 40. In short, any contact structure can be employed as long as it allows heat to be conducted. The use of the heat transfer sheet 70 facilitates thin and broad contact, and therefore is advantageous in view of the productivity and the heat dissipation effect.

### Other Embodiments

The concave portions 320 extending in the vertical direction are provided also in the lateral sides of the projecting portion 31 in the above-described embodiment. However, the concave portions 320 may extend in an oblique direction or the horizontal direction in the lateral sides of the projecting portion 31. Alternatively, the concave portion 320 may be omitted in the lateral sides of the projecting portion 31. That is, the concave portions 320 are provided preferably at least above the projecting portion 31 so as to extend in the vertical direction and align in the horizontal direction.

Further, the concave portions 320 are not necessarily provided in parallel to each other, and may be provided spreading radially from the projecting portion 31, for example.

Furthermore, the drawn portion extending in a particular direction is not necessarily a concave portion recessed toward the chassis 40, and may be a convex portion projecting toward the side opposite to the chassis 40.

Further, it also is possible to form the back cover 30 using a molded resin with a conductive film formed thereon. That is, the “drawn portion” of the present invention is not restricted to being formed by drawing a metal plate, and may be a material that has been molded into the shape in advance.

The present invention is suitable for thin image display devices such as a plasma display device.

The present invention may be embodied in other forms without departing from the spirit or essential characteristics thereof. The embodiments described in this specification are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An image display device comprising:
a display panel for displaying an image;
a chassis supporting the display panel on its front surface;
circuit boards arranged within a specific region of a back surface of the chassis; and
a back cover having an edge portion that covers the outside of the specific region of the back surface of the chassis and a projecting portion that projects inside the edge portion toward a side opposite to the chassis and that accommodates the circuit boards, wherein
the edge portion includes a plurality of drawn portions extending in a particular direction.

2. The image display device according to claim 1, wherein
the plurality of the drawn portions each are a concave portion recessed toward the chassis.

3. The image display device according to claim 2, wherein
the concave portion is in contact with the back surface of the chassis directly or via a heat conductive member.

4. The image display device according to claim 2, wherein
the image display device is positioned with the display panel in an upright position, and
the concave portions are provided at least above the projecting portion so as to extend in the vertical direction and align in the horizontal direction.

5. The image display device according to claim 4, wherein
the edge portion is provided with air inlets, while the projecting portion is provided with air outlets, and
the image display device further comprises a plurality of fans provided inside the projecting portion, the fans being configured to cause airflow from the air inlets to the air outlets between the chassis and the back cover.

6. The image display device according to claim 5, wherein
the plurality of the fans each are arranged at a position corresponding to a middle between adjacent pairs of the concave portions.
